(19) United States
(12) Patent Application Publication
(10) Pub. No.: US 2018/0022016 A1
(43) Pub. Date: Jan. 25, 2018

(54) TEMPLATE FOR IMPRINT

(71) Applicants: SHIBAURA MECHATRONICS CORPORATION, Yokohama-shi (JP); TOSHIBA MEMORY CORPORATION, Minato-ku (JP)

(72) Inventors: Satoshi NAKAMURA, Yokohama-shi (JP); Kensuke DEMURA, Yokohama-shi (JP); Daisuke MATSUSHIMA, Yokohama-shi (JP); Masayuki HATANO, Minato-ku (JP); Hiroyuki KASHIWAGI, Minato-ku (JP)

(73) Assignees: SHIBAURA MECHATRONICS CORPORATION, Yokohama-shi (JP); TOSHIBA MEMORY CORPORATION, Minato-ku (JP)

(21) Appl. No.: 15/720,898

(22) Filed: Sep. 29, 2017

Related U.S. Application Data
(63) Continuation of application No. PCT/JP2016/060816, filed on Mar. 31, 2016.

(30) Foreign Application Priority Data
Mar. 31, 2015 (JP) 2015-074108

(51) Int. Cl. B29C 59/02

(52) U.S. Cl. CPC B29C 59/02; B29C 35/0888

(57) ABSTRACT

According to one embodiment, a template for imprint includes a base, a convex portion, and a liquid-repellent layer. The base has a main surface. The convex portion is provided on the main surface. The convex portion has an end surface on a side opposite to the main surface, and a concavo-convex pattern to be pressed against a liquid material to be transferred is formed on the end surface. The liquid-repellent layer is formed on at least the side surface of the convex portion so as to avoid the concavo-convex pattern. The liquid-repellent layer repels the liquid material to be transferred.

### CROSS-REFERENCE TO THE RELATED APPLICATION

This application is based upon and claims the benefit of priority from International Application No. PCT/JP2016/060816, filed on Mar. 31, 2016 and Japanese Patent Application No. 2015-074108, filed on Mar. 31, 2015; the entire contents of all of which are incorporated herein by reference.

### FIELD

Embodiments described herein relate generally to a template for imprint.

### BACKGROUND

In recent years, an imprinting method has been proposed as a method for forming a fine pattern on a workpiece such as a semiconductor substrate. In this imprinting method, a mold (master) having a concavo-convex pattern formed thereon is pressed against the surface of a liquid material to be transferred (for example, photocurable resin) such as a resist applied on a workpiece. Then, light is irradiated from the surface opposite to the surface on which the pattern is formed, and the mold is removed from the cured material to be transferred. Thereby, the concavo-convex pattern is transferred to the material to be transferred. A template is used as a mold to be pressed against the surface of the liquid material to be transferred. This template is also called mold, imprint mold or stamper.

The template is formed of quartz or the like having high translucency so that light such as ultraviolet rays is easily transmitted in a step (transfer step) of curing the material to be transferred. The template is provided with a convex portion (convexity) on its main surface, and a concavo-convex pattern to be pressed against the liquid material to be transferred is formed on the convex portion. For example, the convex portion having a concavo-convex pattern is referred to as “mesa portion”, and a portion other than the mesa portion on the main surface of the template is referred to as “off-mesa portion”.

However, when the template is pressed against the liquid material to be transferred, the liquid material to be transferred seeps out from the end of the convex portion. Although it is a small amount, the liquid material to be transferred having seeped out may sometimes be raised along the side surface (side wall) of the convex portion. The material to be transferred adhering to the side surface of the convex portion is cured in that state by light irradiation. Accordingly, when the template is separated from the material to be transferred, a raised portion is present in the material to be transferred, resulting in the occurrence of pattern abnormality.

In addition, when the template is separated from the material to be transferred, the raised portion of the material to be transferred sticks to the template. It thereafter may drop on the material to be transferred at some timing and become dust. If the template is pressed onto the dropped dust, the concavo-convex pattern on the template may be damaged, or the dropped dust enters in the concavo-convex pattern on the template and becomes foreign matter. Thus, template abnormality occurs. Further, if pattern transfer is continuously performed using a template having such a damaged concavo-convex pattern or a template into which a foreign matter has entered, a defect is generated in the pattern of the material to be transferred, thus resulting in the occurrence of pattern abnormality.

### BRIEF DESCRIPTION OF THE DRAWINGS

FIG. 1 is a cross-sectional view (a cross-sectional view taken along line 1-1 in FIG. 2) illustrating a schematic configuration of a template according to a first embodiment;

FIG. 2 is a plan view schematically illustrating the template of the first embodiment;

FIG. 3 is an explanatory diagram for explaining an imprint process using the template of the first embodiment;

FIG. 4 is an explanatory diagram for explaining an imprint process using a template of a comparative example according to the first embodiment;

FIG. 5 is a cross-sectional view illustrating a schematic configuration of a template according to a second embodiment; and

FIG. 6 is a cross-sectional view illustrating a schematic configuration of a template according to a third embodiment.

### DETAILED DESCRIPTION

According to one embodiment, a template for imprint includes a base, a convex portion, and a liquid-repellent layer. The base has a main surface. The convex portion is provided on the main surface. The convex portion has an end surface on a side opposite to the main surface, and a concavo-convex pattern to be pressed against a liquid material to be transferred is formed on the end surface. The liquid-repellent layer is formed on at least the side surface of the convex portion so as to avoid the concavo-convex pattern. The liquid-repellent layer repels the liquid material to be transferred.

### First Embodiment

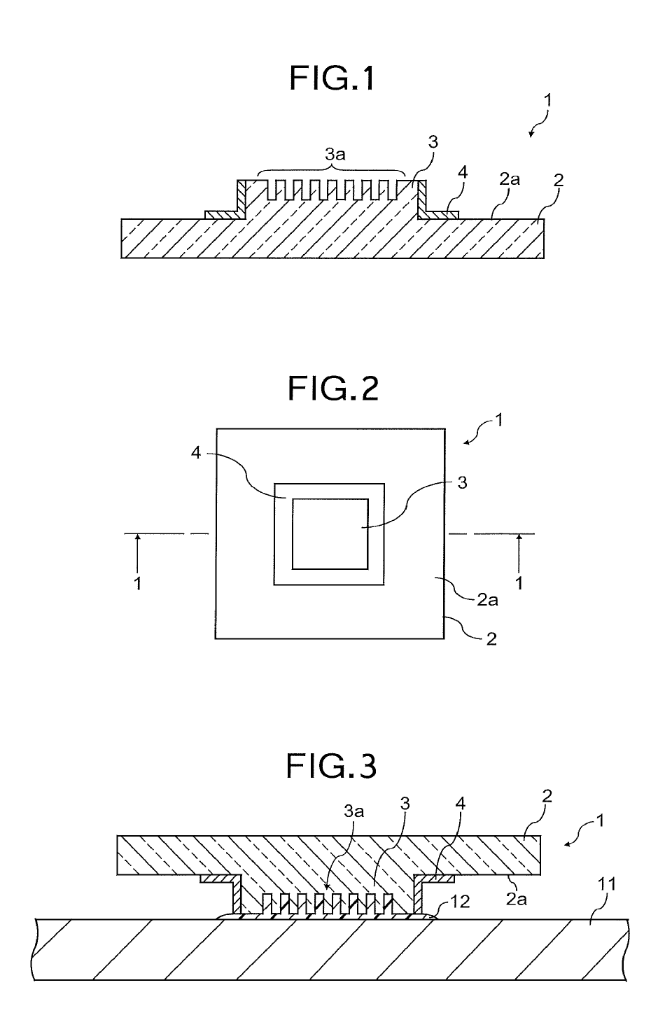

A first embodiment will be described with reference to FIGS. 1 to 4.

As illustrated in FIGS. 1 and 2, an imprint template 1 according to the first embodiment includes a base 2 having a main surface 2a, a convex portion 3 provided on the main surface 2a of the base 2, and a liquid-repellent layer 4 formed on a side surface of the convex portion 3 and a part of the main surface 2a connected to the side surface.

The base 2 has translucency, and is formed in a plate shape in which the main surface 2a is a flat surface. The plate shape of the base 2 is, for example, square or rectangular; however, the shape is not particularly limited. For example, a substrate having high translucency such as a quartz substrate can be used as the base 2. Note that light such as ultraviolet rays is irradiated to the opposite surface of the main surface 2a.

The convex portion 3 has translucency, and is integrally formed with the base 2 from the same material. A concavo-convex pattern 3a is formed on an end surface of the convex portion 3, that is, the surface (upper surface in FIG. 1) opposite to the main surface 2a side of the convex portion 3. The concavo-convex pattern 3a is pressed against a liquid material to be transferred (for example, photocurable resin). The pattern region in which the concavo-convex pattern 3a is formed on the end surface of the convex portion is, for example, a square or rectangular region; however, the shape is not particularly limited.

The liquid-repellent layer 4 has translucency. The liquid-repellent layer 4 is provided on at least the side surface (side wall) of the convex portion 3 so as to avoid the concavo-convex pattern 3a on the convex portion 3, and further, is arranged in a predetermined region on the main surface 2a continuous to the side surface of the convex portion 3. As illustrated in FIG. 2, the predetermined region is an annular region around the convex portion 3 in a region other than the convex portion 3 on the main surface 2a when the template 1 is viewed in a plan view. Since the convex portion 3 has, for example, a square or a rectangular parallelepiped shape, the predetermined region around it on the main surface 2a is a quadrangular annular region; however, the shape of the convex portion 3 and that of the annular predetermined region are not particularly limited. The liquid-repellent layer 4 is made of a material that repels a liquid material to be transferred. For example, a silane coupling agent may be used as the material for the liquid-repellent layer 4.

In an imprint process, as illustrated in FIG. 3, the concavo-convex pattern 3a on the convex portion 3 is directed to the liquid material to be transferred on a workpiece (for example, semiconductor substrate) 11, and the template 1 is pressed against the liquid material to be transferred 12 on the workpiece 11. At this time, the liquid material to be transferred 12 seeps out from between the end surface of the convex portion 3 and the workpiece 11. However, since the liquid repellent layer 4 is formed on the side surface of the convex portion 3, the seeping liquid material to be transferred 12 is repelled by the liquid-repellent layer 4. In other words, the liquid-repellent layer 4 has the function of repelling the liquid material to be transferred 12. This suppresses the adhesion of the liquid material to be transferred 12 to the side surface of the convex portion 3. Thus, the liquid material to be transferred is suppressed from being raised along the side surface of the convex portion 3.

Next, in a state where the concavo-convex pattern 3a on the convex portion 3 is pressed against the liquid material to be transferred 12, the liquid material to be transferred 12 is irradiated with light such as ultraviolet light from the surface opposite to the surface on which the concavo-convex pattern 3a is formed. When the liquid material to be transferred 12 is cured by the light irradiation, the template 1 is separated from the cured material to be transferred 12, and the concavo-convex pattern 3a on the convex portion 3 is transferred to the liquid material to be transferred 12. In general, such an imprint process is repeated over the entire surface of the workpiece 11, and pattern transfer is repeatedly performed; however, the number of times of imprint is not particularly limited.

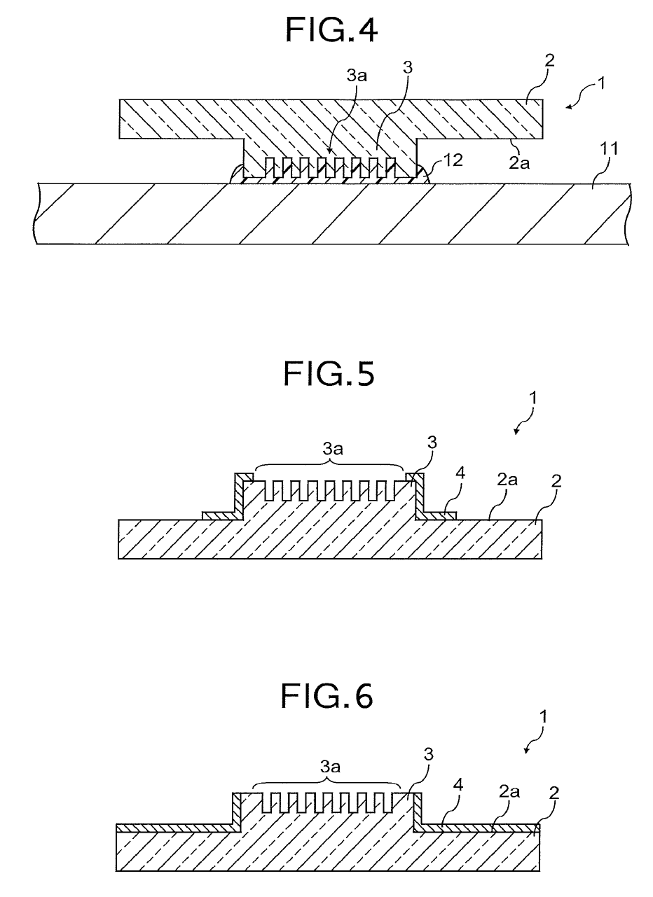

As a comparative example, as illustrated in FIG. 4, when the liquid-repellent layer 4 is not formed on the side surface of the convex portion 3, the seeping liquid material to be transferred 12 adheres to the side surface of the convex portion 3, and accordingly, it is raised along the side surface of the convex portion 3 due to surface tension. In this state, the liquid material to be transferred 12 is cured by light irradiation. Thereafter, when the template 1 is separated from the liquid material to be transferred 12, unnecessary raised portion is present on the cured material to be transferred 12, or the raised portion adheres to the template 1.

The liquid material to be transferred 12 is not limited to a liquid photocurable resin but may be, for example, a liquid thermosetting resin. In this case, the liquid material to be transferred 12 is cured by heating it with a heating unit such as a heater or a light source.

As described above, according to the first embodiment, the liquid-repellent layer 4 that repels the liquid material to be transferred 12 is provided at least on the side surface of the convex portion 3 so as to avoid the concavo-convex pattern 3a on the convex portion 3. With this, in the imprint process, the liquid material to be transferred 12 that has seeped out from between the convex portion 3 and the workpiece 11 is repelled by the liquid-repellent layer 4. This suppresses the adhesion of the liquid material to be transferred 12 to the side surface of the convex portion 3. Thereby, it is possible to suppress a part of the cured material to be transferred 12 from being raised, and suppress the occurrence of pattern abnormality. Moreover, it is possible to suppress the breakage of the template 1 and the biting of a foreign substance, and suppress the occurrence of pattern abnormality and template abnormality.

In the imprint process, when the liquid material to be transferred 12 adheres to the side surface of the convex portion 3, generally, the template 1 is cleaned with a chemical solution to remove the liquid material to be transferred 12. However, according to the first embodiment, it is possible to suppress the material to be transferred 12 from adhering to the side surface of the convex portion 3 as described above. This eliminates the need of the cleaning step for removing the material to be transferred 12 from the side surface of the convex portion 3. Thereby, it is possible to eliminate the cleaning step of the template W after use as well as to prevent the pattern wear of the template W caused by the cleaning liquid and damage such as pattern collapse. As a result, the occurrence of template abnormality can be suppressed.

It is important to form the liquid-repellent layer 4 on at least the side surface of the convex portion 3 in such a way as to avoid the concavo-convex pattern 3a so as not to form the liquid-repellent layer 4 on the concavo-convex pattern 3a. This is to avoid poor transfer (misprinting) of the concavo-convex pattern 3a with respect to the liquid material to be transferred 12. That is, the concavo-convex pattern 3a is a fine pattern having a width of nanometer size. Therefore, if the liquid-repellent layer 4 is formed on the concavo-convex pattern 3a, even if it is a little, the accuracy of the dimensional width of the concavo-convex pattern 3a cannot be maintained due to the thickness of the liquid-repellent layer 4 added thereto. As a result, pattern abnormality occurs at the time of transfer.

### Second Embodiment

A second embodiment will be described with reference to FIG. 5. In the second embodiment, a description is given of differences from the first embodiment (formation region of the liquid-repellent layer 4), and the same description will not be repeated.

As illustrated in FIG. 5, in addition to the side surface of the convex portion 3 and a predetermined annular region on the main surface 2a continuous to the side surface, the liquid-repellent layer 4 of the second embodiment is formed on the end surface (upper surface in FIG. 5) of the convex portion 3 so as to avoid the concavo-convex pattern 3a on the convex portion 3. Accordingly, the liquid-repellent layer 4 is present also on the end surface of the convex portion 3. As a result, in the imprint process, the liquid material to be transferred 12 is suppressed from seeping out from between the end surface of the convex portion 3 and the workpiece 11 due to the step corresponding to the thickness of the liquid-repellent layer 4. Even if the liquid material to be transferred 12 seeps out from between the end surface of the convex portion 3 and the workpiece 11, as in the first embodiment, it is repelled by the liquid repellent layer 4 present on the side surface of the convex portion 3. Thus, it is possible to suppress the liquid material to be transferred 12 from adhering to the side surface of the convex portion 3.

As described above, according to the second embodiment, it is possible to achieve the same effects as those of the first embodiment. That is, it is possible to reliably suppress the liquid material to be transferred 12 from adhering to the side surface of the convex portion 3. Further, it is possible to reliably suppress the occurrence of pattern abnormality and template abnormality.

### Third Embodiment

A third embodiment will be described with reference to FIG. 6. In the third embodiment, a description is given of differences from the first embodiment (formation region of the liquid-repellent layer 4), and the same description will not be repeated.

As illustrated in FIG. 6, in addition to the side surfaces of the convex portion 3, the liquid-repellent layer 4 of the third embodiment is formed from the side surface of the convex portion 3 to an edge of the main surface 2a so as to avoid the concavo-convex pattern 3a on the convex portion 3. That is, the liquid-repellent layer 4 is formed over the entire main surface 2a other than the convex portion 3. Thereby, it is possible to prevent the liquid material to be transferred 12 from adhering to the main surface 2a of the template 1 during the imprint process as well as to keep the template 1 clean.

As described above, according to the third embodiment, it is possible to achieve the same effects as those of the first embodiment. Moreover, the template 1 can be kept clean. Incidentally, if imprinting is performed in a state where the liquid material to be transferred 12 adheres to the template 1, it leads to the occurrence of pattern abnormality and template abnormality as described above. Therefore, it is important to keep the template 1 clean.

### Other Embodiments

In the first to third embodiments described above, it is sufficient if the liquid-repellent layer 4 is formed on at least the side surface of the convex portion 3 so as to avoid the concavo-convex pattern 3a on the convex portion 3. As in the second and third embodiments, the liquid-repellent layer 4 may be formed on a part of the end surface of the convex portion 3 or on the entire main surface 2a other than the convex portion 3 in addition to the side surface of the convex portion 3. Besides, it is only required to form the liquid-repellent layer 4 on a portion of the side surface of the convex portion 3 that comes in contact with the material to be transferred 12, and the liquid-repellent layer 4 may be formed on a part of the side surface of the convex portion 3. Further, it is also possible to combine the second embodiment and the third embodiment. That is, in addition to the side surface of the convex portion 3, the liquid repellent layer 4 may be formed on a part of the end surface of the convex portion 3 and the entire main surface 2a other than the convex portion 3.

The liquid-repellent layer 4 is not limited to a single layer, and a stack of a plurality of layers may be used. Further, the side surface (side wall) of the convex portion 3 may be perpendicular to the main surface 2a or may be inclined. In addition, the side surface of the convex portion 3 may be flat or may have a step.

Although a semiconductor substrate is exemplified as the workpiece 11, it is not limited thereto. The workpiece 11 may be a quartz substrate used as a replica template.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template for imprint, comprising:
a base having a main surface;
a convex portion provided on the main surface and having an end surface on a side opposite to the main surface, wherein a concavo-convex pattern to be pressed against a liquid material to be transferred is formed on the end surface; and
a liquid-repellent layer that is formed on at least a side surface of the convex portion so as to avoid the concavo-convex pattern, and repels the liquid material to be transferred.

2. The template for imprint according to claim 1, wherein the liquid-repellent layer is formed also on the main surface in addition to the side surface of the convex portion.

3. The template for imprint according to claim 1, wherein the liquid-repellent layer is formed also on the end surface so as to avoid the concavo-convex pattern in addition to the side surface of the convex portion.

4. The template for imprint according to claim 2, wherein the liquid-repellent layer is formed also on the end surface so as to avoid the concavo-convex pattern in addition to the side surface of the convex portion.

5. The template for imprint according to claim 1, wherein the liquid-repellent layer has translucency.

6. The template for imprint according to claim 2, wherein the liquid-repellent layer has translucency.

7. The template for imprint according to claim 3, wherein the liquid-repellent layer has translucency.

8. The template for imprint according to claim 4, wherein the liquid-repellent layer has translucency.
